(19) United States
(12) Patent Application Publication
(10) Pub. No.: US 2008/0062244 A1
(43) Pub. Date: Mar. 13, 2008

(54) Laser writing

(75) Inventors: Kuohua Wu, Tucson, AZ (US); Andrew L. Van Brocklin, Corvallis, OR (US); Cari L. Dorsh, McMinnville, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/518,640

(22) Filed: Sep. 11, 2006

(51) Int. Cl. B41J 27/00

(52) U.S. Cl. 347/256; 369/94

(57) ABSTRACT

Various methods and embodiments for laser writing are disclosed.

### BACKGROUND

Lasers are sometimes employed to write data and/or labels upon storage media. The writing of data or labels upon such media is sometimes tedious and time-consuming.

### BRIEF DESCRIPTION OF THE DRAWINGS

is a systematic illustration of one example of a laser writing system writing upon optical media according to an example embodiment.

FIG. 2 is a sectional view of another embodiment of the optical media of FIG. 1 according to an example embodiment.

FIG. 3 is a sectional view of another embodiment of the optical media of FIG. 1 according to an example embodiment.

FIG. 4 is a sectional view of another embodiment of the optical media of FIG. 1 according to an example embodiment.

FIG. 5 is a schematic illustration of another embodiment of the laser writing system of FIG. 1 writing upon optical media according to an example embodiment.

### DETAILED DESCRIPTION OF THE EXAMPLE EMBODIMENTS

FIG. 1 schematically illustrates one example of laser writing system 20 according to an example embodiment. Laser writing system 20 is configured to concurrently write to different layers of a disc or other optical media using multiple lasers. System 20 generally includes optical pickup unit 22, drivers 24a, 24b and 24c (collectively referred to as drivers 24) and controller 40. Optical pickup unit 22 is configured to direct multiple laser beams at an optical medium 42. In particular embodiments, optical pickup unit 22 may additionally include one or more optical sensing devices (not shown), facilitating the reading of data from an optical medium. As shown by FIG. 1, optical pickup unit 22 generally includes lasers 44a, 44b and 44c (collectively referred to as lasers 44), optics 46a, 46b and 46c (collectively referred to as optics 46), alignment optics 48, 50 and objective lens 52. Lasers 44 comprise sources of coherent light (a laser beam) such as a laser diode. Lasers 44 are configured to emit distinct laser beams having different wavelengths. In one embodiment, each of lasers 44 emit a laser beam having a wavelength substantially equal to that of one of existing optical media constructions. For example, in one embodiment, laser 44a comprises a laser configured to write upon a compact disc (CD) media construction, wherein the laser provided by laser 44a has a wavelength of approximately 780 nm. Laser 44b comprises a laser configured to write upon a digital versatile disc (DVD) media construction, wherein the laser provided by laser 44b has a wavelength of approximately 650 nm. Laser 44c comprises a laser configured to write upon a Blu-ray media construction, wherein the laser provided by laser 44c has a wavelength of approximately 405 nm. In still other embodiments, one or more of lasers 44 may be configured to emit laser light having other currently existing or future developed optical media constructions. Because optical pickup unit 22 includes lasers 44 configured to emit laser beams having wavelengths for writing upon existing optical media constructions, lasers 44 may comprise existing laser components and configurations, reducing the cost of optical pickup unit 22. In other embodiments, one or more of lasers 44 may comprise customized lasers or lasers configured to emit laser beams having custom wavelengths or wavelengths not associated with an existing optical media construction.

Optics 46 are associated with each of lasers 44 and direct coherent light generated by lasers 44 towards alignment optics 48 and 50. In the example illustrated, optics 46a and 46b direct laser light from lasers 44a and 44b, respectively, towards alignment optics 48. Optics 46c directs laser light from laser 44c towards alignment optics 50. In one embodiment, optics 46 each comprise one or more lenses or mirrors.

Alignment optics 48, 50 each comprise one or more optical components configured to redirect laser light from lasers 44 towards objective lens 52. In the example illustrated, optics 48, 50 align laser light received from lasers 44 such that the laser beams are directed towards objective lens 52 along a substantially coextensive or aligned optical path. In the particular example illustrated, optics 48 aligns laser light from lasers 44a and 44b. Optics 50 further directs and aligns laser light from laser 44c with the already aligned laser light from lasers 44a and 44b. In the particular example illustrated, optics 48 and optics 50 comprise a single optical element, a dichroic mirror. In other embodiments, one or both of optics 48 and 50 may comprise other optical arrangements or components configured to align laser light or laser beams from multiple lasers.

Objective lens 52 comprises a lens configured to receive the aligned laser light from lasers 44 and to direct and focus the aligned laser light on to multiple layers of optical media 42. In particular embodiments, objective lens 52 may be movable along an axis substantially perpendicular to the layers of optical media 42 to adjust focus or the focal point of the lasers. In particular embodiments, objective lens 52 may additionally or alternatively be movable in a direction substantially parallel to the layers of optical media 42 to facilitate finite position adjustments, such as tracking, of the laser beams with respect to optical media 42.

Optical media 42 comprises a structure including multiple layers configured to be concurrently written upon by writing system 20. Optical media 42 includes writable layers 70a, 70b and 70c (collectively referred to as writable layers 70) and spacer layers 72 and 74. Writable layers 70 each comprise one or more layers of one or more materials or elements configured to change one or more optical properties in response to being irradiated with laser light. Such light may be in the visible, infrared or ultraviolet light spectrums. According to one embodiment, each of layers 70 comprises one or more thermochromic materials configure change optical properties (such as optical density) when subjected to energy such as infrared radiation, ultraviolet radiation or visible light.

For example, in one embodiment, such thermochromic materials may include a leuco dye which may change color with the application of heat or in the presence of an activator (developer). In one embodiment, the dye may include fluoran-based compounds. In some embodiments, layers 70 may additionally include a radiation-absorbing material to facilitate absorption of one or more wavelengths of marking radiation. Examples of such a radiation-absorbing material include an infrared dye. In one embodiment, each of layers 70 may be configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, each of layers 70 may alternatively include other materials.

According to one embodiment, each of layers 70 may have a different composition such that each of layers 70 reflect or absorb light differently upon being irradiated with substantially similar amounts of energy. For example, in one embodiment, one or more of layers 70 may be configured to reflect (or absorb) a different color of light upon being irradiated. In particular embodiments, layers 70 may be configured to reflect different shades of a particular color of visible light upon being irradiated. In some of embodiments, layers 70 may each be configured to reflect a different color of light, wherein the particular shade of light reflected by layer depends upon the extent to which it is irradiated. In some embodiments, layers 70 may be configured to reflect different monochromatic or grayscale shades of visible light.

According to one embodiment, layers 70 may be configured to absorb colors of light that when selectively combined with one another reflect a range of multiple colors. For example, in one embodiment, layers 70 may be configured to absorb distinct wavelengths of light so to provide cyan, magenta and yellow visible light upon being irradiated, facilitating half-toning or other techniques to provide a large number of colors for optical media 42.

In such embodiments where layers 70 reflect different colors, shades of colors or shades of monochromatic light, the reflection of light by layers 70 may be used to enhance labeling of optical media 42. For purposes of this disclosure, the term “label” shall mean any image, graphic, photo, drawing, picture, alphanumeric symbols, design and the like that are visible to a human eye. Such labeling may directly communicate information regarding the content or characteristic of the data on disc 20 to a person. Such labeling may also alternatively visually communicate other un-encoded information to a person.

In lieu of being written upon with labeling, layers 70 may alternatively be written upon with data. For purposes of this disclosure, the term “data” shall mean information that is encoded so as to be machine or computer-readable. For example, information may be digitally encoded with binary bits or values. Such data may have different formats such as various presently or future created music, photo and document formats. Although the existence of the data on the disc may, in some embodiments, be visually seen by the human eye as darker or lighter rings on the disc, the content or information encoded by the data is generally not readable by a human eye. In other words, the darker or lighter rings that may be viewed on the disc do not communicate information to a person viewing the rings and do not identify or label characteristics of the data.

Spacer layers 72 and 74 each comprise one or more layers of one or more transparent materials extending between layers 70. Layers 72 and 74 space apart layers 70 by distances substantially equal to the working distance differences between the different wavelengths of laser light used by writing system 20. For purposes of this application, the term “working distance” shall mean the distance from the final objective lens focusing the laser beams and the focal point of such laser beams. Laser beams of different wavelengths have different focal points when focused by the same lens. The “working distance difference” of two laser beams is the difference between their respective focal points when transmitted through the same optical system. As a result of the different working distance difference, laser light from each of lasers 44 and directed to optical media 42 by objective lens 52 concurrently irradiates the different layers 70 of optical media 42. According to one embodiment, spacer layers 72, 74 comprise polycarbonate. In other embodiments, spacer layers 72, 74 may be formed from other materials. In the example illustrated, layer 72 extends between layers 70a and 70b. Layer 74 extends between layers 70b and 70c.

According to one embodiment, laser 44a emits laser light 80a having a wavelength of approximately 405 nm (CD writing construction), laser 44b emits laser light 80b having a wavelength of approximately 650 nm (DVD writing construction) and laser 44c emits laser light 80c having a wavelength of approximately 780 nanometers (Blu-ray writing construction). In such an embodiment, spacer layer 72 has a thickness of at least about 195 μm, less than or equal to about 405 μm and nominally about 300 μm, the working distance difference between laser light 80a and 80b. Spacer layer 74 has a thickness of at least about 225 μm, less than or equal to about 475 micro letters and nominally about 350 μm, the working distance difference between laser light 80b and 80c. In other embodiments, these thicknesses may vary depending upon a dispersion of the objective lens or a material index of the objective lens 52 of the particular system 20. As a result, laser beams 80a, 80b and 80c (collectively referred to as laser beams or laser lights 80) concurrently irradiate layers 70a, 70b and 70c, respectively, to independently write labels or data upon such layers 70.

Although media 42 is illustrated as including three writable layers 70 spaced part by two intermediate spacer layers 72, 74, in other embodiments media 42 may alternatively include two writable layers separated by a single spacer layer or may include greater than three spaced apart writable layers. Optical media 42 may include additional layers as well. For example, optical media 42 may additionally include one or more reflective layers, one or more protective coatings or layers, and one or more label or data layers configured to be optically read by a laser and sensing device, configured to be visibly seen by an observer or configured to be optically written upon by a laser from an opposite side of media 42. In one embodiment, optical media 42 may comprise an annular disc. In other embodiments, media 42 may have other configurations.

Drivers 24 comprise integrated circuits configured to provide their respective lasers 44 with modulated electrical current which drives the lasers 44. Although drivers 24 are illustrated as separate elements, in some embodiments, drivers 24 may be provided by a single integrated circuit or other electronic device.

Controller 40 comprises one or more processing units configure to generate control signals for directing drivers 24 to appropriately or selectively modulate and control the laser light being emitted by lasers 44 to selectively write upon one or more of layers 70 of optical media 42. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 40 is not limited to any specific combination of hardware circuitry and software, nor to any particular source for the instructions executed by the processing unit.

In operation, controller 40 generates control signals based upon either data information to be written to one or more of layers 70 or based upon label information (for example bitmap information) to be written on one or more of layers 70 of optical media 42. In response to receiving such control signals, drivers 24 supply modulated electrical current to their associated lasers 44 to modulate laser beams 80. As a result, different portions of each of layers 70 are differently and concurrently irradiated by laser beams 80. Because multiple layers 70 are concurrently written upon, the writing of label or data information to optical media 42 may be less time-consuming. In those embodiments in which optical pickup unit 22 utilizes lasers 44 configured to write upon existing optical media constructions (CD, DVD, Blu-ray and others), optical pick up unit 22 may comprise an existing superdrive optical pick up unit (i.e., an optical drive configured to write or read or multiple optical media constructions at different times) which has been modified to include alignment optics, reducing cost.

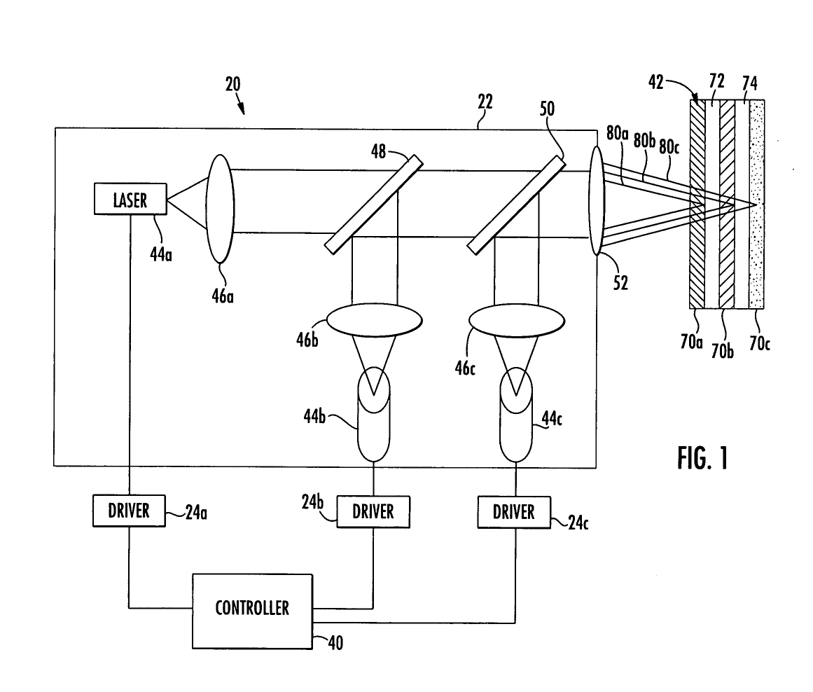

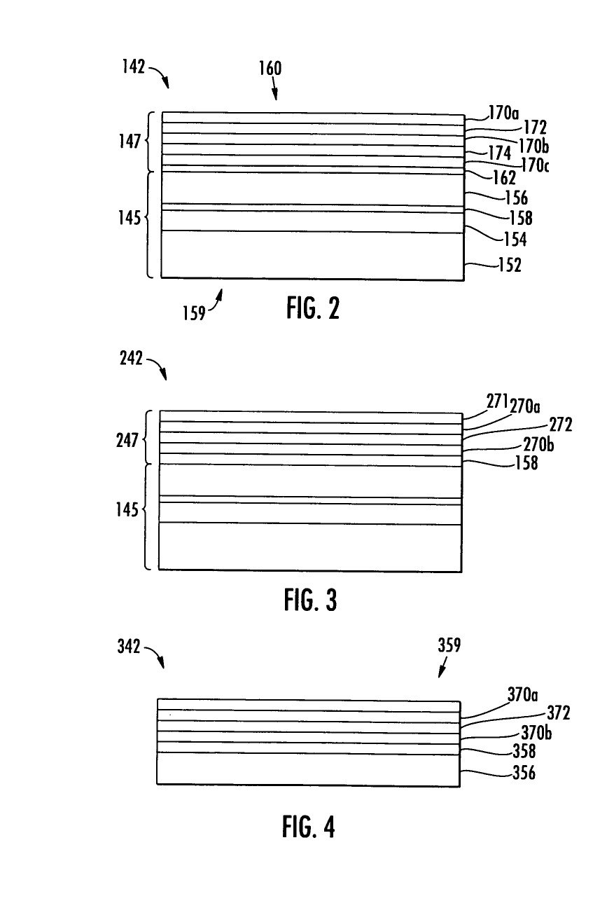

FIGS. 2-4 are sectional views illustrating examples of optical media that may be written upon by writing system 20 (shown in FIG. 1). FIG. 2 is a sectional view of a portion of optical media 142, another embodiment of optical media 42. In one embodiment, optical media 142 comprises an annular disc. Optical media 142 includes data portion 145 and a label portion 147. Data portion 145 comprises that portion of media 142 configure to store data. Data portion 145 is configured to facilitate the writing of data to media 142 using a source of coherent light such as a laser. Data portion 145 includes substrate layer 152, data layer 154, substrate layer 156 and reflective layer 158.

Substrate layer 152 comprises a layer of transparent material configured to permit the transmission of coherent light therethrough to layers 154 and 158 and the reflection of light from layer 158 back through layer 152 for being read by a sensing device facing data side 159 of media 142. According to one embodiment, layer 152 additionally serves as a base or supporting layer for layer 154 during fabrication of media 142. According to one embodiment, layer 152 comprises polycarbonate. In other embodiments, layer 152 may be formed from other transparent materials.

Layer 154 comprises one or more layers of one or more materials configured to store data. In one embodiment, layer 154 is configured to be written upon by electromagnetic energy, such as a laser. In particular, layer 154 is configured to be written upon with a laser so as to encode binary or other machine-readable data in layer 154. In one embodiment, such data is written in layer 154 along spiral grooves extending about a rotational axis of media 142. In one embodiment, layer 154 comprises a layer or film of material which changes in optical characteristic upon being irradiated with a laser. Examples of such a material include a thermochromic material or phase-change material other material configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, writable layer 154 may alternatively include other materials. In other embodiments, other materials that change between different optical states upon being irradiated with a laser may be employed.

In other embodiments, layer 154 may be preconfigured or fabricated with grooves or pits representing a fixed set of data. Examples of data portion 145 which is preconfigured include, but are not limited to, discs that are stamped or other wise formed from masters. Such preconfigured data portions 145 include preconfigured CDs, DVDs, Blu-ray discs and the like.

Substrate layer 156 comprises one or more layers of one or more materials spacing data layer 154 from label portion 147. In one embodiment, layer 156 further serves as a base or foundation layer upon which reflective layer 158 is formed during fabrication of media 142. In one embodiment in which data portion 145 comprises a DVD, layer 156 has a thickness of about 600 μm. In another embodiment in which data portion 145 comprises a Blu-ray disc, layer 156 has a thickness of about 1100 μm. In one embodiment in which data portion 145 is configured to permit light to be reflected off reflective layer 158 from label side 160 in reviewing label portion 147, layer 156 is formed from a transparent material. According to one embodiment, layer 156 is formed from polycarbonate. In other embodiments, layer 156 may be formed from other transparent, translucent or opaque materials.

Reflective layer 158 comprises one or more layers of one or more reflective materials having sufficient reflectivities so as to reflect light that has passed through data layer 154 back towards an optical sensing device located opposite side 159 of media 142. In one embodiment, layer 158 comprises a layer of one of more metals which are highly reflective such as silver or aluminum. In other embodiments, other reflective metals or nonmetals may be used.

According to one method of fabrication, layer 158 comprises a single film deposited upon substrate layer 156. Layer 154 comprises single layer of writeable material deposited upon substrate layer 152. Layers 156 and 158 and layers 152 and 154 are then stacked and joined to one another with layers 154 and 158 sandwiched between layers 152 in 156. In other embodiments, data portion 145 may be formed in other ways.

Label portion 147 comprises a multilayer arrangement configured such that multiple layers may be concurrently written upon by writing system 20 (shown in FIG. 1). Label portion 147 is coupled to data portion 145 and includes reflective layer 162, writable layers 170a, 170b and 170c (collectively referred to as writable layers 170) and spacer layers 172, 174. Reflective layer 162 comprises one or more layers of one or more materials having sufficient reflectivities so as to reflect visible light that has passed through writable layers 170 back towards a person viewing label side 160 of media 142. In one embodiment, layer 162 comprises a layer of one of more metals which are highly reflective such as silver or aluminum. In other embodiments, other reflective metals or nonmetals may be used. In particular embodiments, reflective layer 162 may be omitted, wherein layer 156 is transparent, permitting light from side 160 to be reflected by layer 158 or wherein light emanating from side 160 is reflected by layers 170.

Layers 170 and spacer layers 172, 174 are substantially similar to layers 70 and spacer layers 72, 74, respectively, described with respect to FIG. 1. However, in the particular example illustrated in FIG. 2, layers 170 are each configured to reflect, absorb or attenuate a different color, shade of color or shade of monochromatic visible light after being irradiated. In one embodiment, layers 170 are configured to reflect cyan, magenta and yellow light upon being irradiated. For example, in one embodiment, layer 170a may be configured to reflect cyan light, layer 170b may be configured to reflect magenta light and layer 170c may be configured to reflect yellow light. Which layer reflects which of the three colors of light may be varied. In other embodiments, layers 170 may be configured to reflect red, green and blue light. In particular embodiments, layers 170 may be configured to reflect different shades of such colors depending upon the degree or extent to which such layers are irradiated. As a result, layers 170 cooperate to provide media 142 with color or grayscale labeling. Because layers 170 may be concurrently written upon by writing system 20, writing of a label to media 142 may be less time-consuming.

FIG. 3 is a sectional view illustrating a portion of media 242, another embodiment of media 42. Media 242 is similar to media 142 except that media 242 includes label portion 247 in lieu of label portion 147. Those remaining elements of media 242 which correspond to elements of media 142 are numbered similarly. Label portion 247 is coupled to data portion 145 and comprises a multilayer arrangement including layers configured to be concurrently written upon by writing system 20 (shown in FIG. 1). Label portion 247 includes layer 158 (described above with respect to media 142), writable layers 270a, 270b (collectively referred to as writable layers 270) and 271, and spacer layer 272. Writable layers 270a and 270b comprise layers of laser writable similar to the material or materials of layers 70 (shown and described with respect to FIG. 1). Layers 270 are spaced apart from one another by spacer layer 272 which comprises a transparent layer formed from a transparent material such as polycarbonate. Spacer layer 272 separates layers 270 by a working distance difference substantially equal to a working distance difference between two of the laser beams 80 provided by writing system 20. As a result, layers to 70 may be concurrently written upon by writing system 20.

Layer 271 is similar to layers 270 in that layer 271 is configured to be written upon by a laser beam 80 from writing system 20. Layer 271 is not spaced from layer 270a by a working distance difference between two of laser beams 80. In the particular example illustrated, layer 271 is directly adjacent to layer 270a. In other embodiments, layer 271 may be spaced from layer 270a by intermediate transparent layers having a thickness less than the working distance difference.

To write upon layer 271, the focus of the laser beam 80 used to write upon layer 270a is adjusted to alternatively write upon layer 271. In one embodiment, such adjustment may be achieved with a focus servo coupled to objective lens 52 of optical pickup unit 22 (shown in FIG. 1). Although layer 271 is illustrated as being above layer 270a, layer 271 may alternatively be below layer 270a or alternatively proximate to layer 270b. In other embodiments, media 242 may include additional writable layers similar to layer 271 proximate to one or more of those writable layers that are spaced from one another by the working distance differences of laser beams 80. Overall, media 242 provides a label portion 247 having three layers, wherein two of the three layers may be concurrently written upon to reduce writing time.

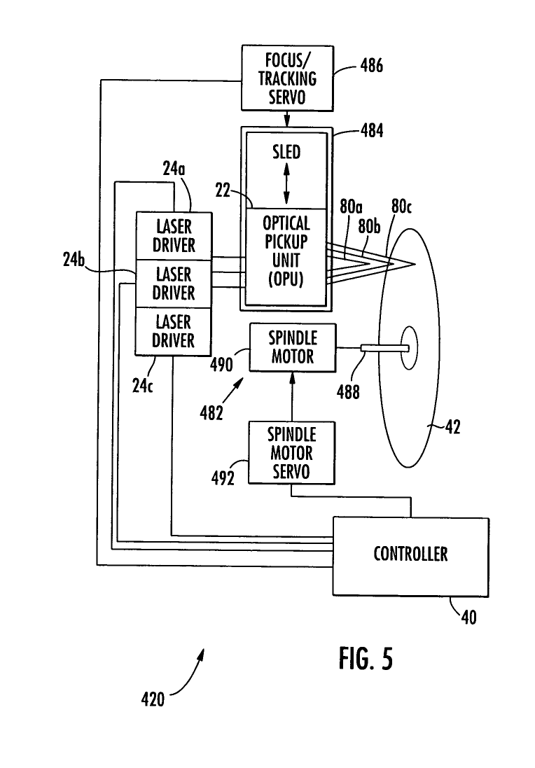

FIG. 4 is a sectional view illustrating a portion of media 342, another embodiment of media 42 (shown in FIG. 1). Like media 42, 142 and 242, media 342 may comprise an annular disc in particular embodiments. Media 342 includes substrate layer 356, reflective layer 358, writable layers 370a and 370b (collectively referred to as writable layers 370) and spacer layer 372. Substrate layer 356 comprises one or more layers of one or more materials serving as a base or foundation upon which the remaining layers of media 342 may be formed. In one embodiment, layer 356 may comprise polycarbonate. In other embodiments, layer 356 may comprise one or more other materials.

Reflective layer 358 comprises one or more layers of one or more reflective materials having sufficient reflectivities so as to reflect light that has passed through layers 370 and 372 back towards an optical sensing device located opposite side 359 of media 142. In one embodiment, layer 358 comprises a layer of one of more metals which are highly reflective such as silver or aluminum. In other embodiments, other reflective metals or nonmetals may be used.

Layers 370 each comprise one or more layers of one or more materials or elements configured to change one or more optical properties in response to being irradiated with laser light. Such light may be in the visible, infrared or ultraviolet light spectrums. Layers 370 are similar to layers 70 (shown described with effective FIG. 1) except that layers 370 are specifically configured to be written upon with data. In one embodiment, layers 370 are configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, writable layer 34 may alternatively include other materials. In other embodiments, other materials that change between different optical states upon being irradiated with a laser may be employed.

Spacer layer 372 comprises one or more layers of one or more transparent materials between layers 370. In one embodiment, spacer layer 372 comprises polycarbonate. In other embodiments, spacer layer 372 may have other configurations. Spacer layer 372 spaces layer 370a from layer 370b by a distant substantially equal to a working distance difference between two of laser beams 80. For example, in one embodiment, spacer layer 372 may have a thickness of 300 μm, a working distance difference between laser beam 80a from laser 44a end of laser beam 80b from laser 44b, permitting lasers 44a and 44b to concurrently write data to layers 370. Such data may be read from layers 370 by selectively focusing a laser onto one of layers 370 and sensing light that is passed through the layer 370 and that has been reflected by layer 358. During such reading, signals resulting from the layer 370 not being read may be filtered out.

FIG. 5 schematically illustrates optical writing system 420, another embodiment of the system 20. System 420 includes optical pickup unit 22, drivers 24a, 24b and 24c, and controller 40. As shown by FIG. 5, system 420 additionally includes rotary actuator 482, sled 484 and servo 486. Rotary actuator 482 comprises a device configured to rotate media 42 about axis 488. Rotary actuator 482 includes spindle motor 490 and spindle motor servo 492. Spindle motor 490 comprises a motor configured to rotate media 42. Spindle motor servo 492 comprises a device to sense the speed of which spindle motor 490 rotate media 42 and to facilitate control of motor 490 to facilitate adjustment of the speed at which spindle motor 490 rotates media 42. In particular embodiments, spindle motor servo 492 may be omitted.

Sled 484 comprises a mechanism configured to move optical pickup unit 22 radially with respect to media 42. Sled 484 includes a guide and an actuator (not shown). The guide comprises a structure configured to physically support optical pickup unit 22 as optical pickup unit 22 is moved relative to media 42. The actuator moves optical pickup unit 22 along the guide relative to media 42. In one embodiment, the actuator may comprise a DC or stepper motor. In other embodiments, other motors or actuators may be employed.

Servo 486 comprises a mechanism configured to move and adjust positioning of the objective lens 52 or other optics of optical pickup unit 22. Servo 486 includes a first actuator configured to move the objective lens in a direction generally perpendicular to a face of media 42 to adjust a focus of the laser generated by optical pickup unit 22. Servo 486 further includes a second actuator configured to move the objective lens 52 in a direction radial with respect to the face of media 42 to adjust tracking of the lasers generated by optical pickup unit 22. In one embodiment, the first and second actuators comprise motors. In particular embodiments, the first and second actuators may comprise voice coils. In other embodiments, other actuators may be used.

In operation, controller 40 generates control signals directing laser drivers 24 provide appropriately modulated electrical currents to the lasers 44 (shown in FIG. 1) of optical pickup unit 22 to generate laser beams. Controller 350 further generates control signals directing sled 484 to grossly position optical pickup unit 22 radially with respect to media 42 and control signals directing servo 486 to precisely position pick up unit 22 or its objective lens 52 (shown in FIG. 1) radially with respect to media 42. In response to control signals from controller 40, servo 486 further precisely positions the objective lens 52 of optical pickup unit 22 to appropriately focus the laser beams on media 42. As a result, multiple layers of media 42 are concurrently written upon. Such writing may be the writing of data, labels or combinations thereof. In those embodiments in which media 242 is alternatively written upon, subsequent to the concurrent writing of two layers spaced apart by the working distance difference between two laser beams 80, controller 40 may generate control signals directing servo 486 to adjust the position of optical pickup unit 22 and objective lens 52 relative to disc 42 to write upon a third layer of media 42. Because system 420 concurrently writes to two or more layers of media 42, writing of data or labels to media 42 is less time-consuming.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a first laser;
a second laser; and
a controller configured to generate control signals, wherein the first laser and the second laser are configured to concurrently write to different layers of a storage medium in response to the control signals.

2. The apparatus of claim 1 further comprising optics configured to concurrently focus light from the first laser and the second laser on the storage medium.

3. The apparatus of claim 2, wherein the optics includes a dichroic mirror configured to direct light from the first laser and from the second laser through a single objective lens.

4. The apparatus of claim 3, wherein the first laser and the second laser are configured such that light from the first laser and light from the second laser have at least partially coextensive paths.

5. The apparatus of claim 4, wherein the first laser is configured to write data to the first storage media construction and wherein the second laser is configured to write data to a second distinct storage media construction.

6. The apparatus of claim 4, wherein the first laser is configured to write data to a compact disc (CD) construction and wherein the second laser is configured to write data to a digital versatile disc (DVD) construction.

7. The apparatus of claim 1, wherein the first laser is configured to provide a first output with the first wavelength and wherein the second laser is configured to provide a second output with a second distinct wavelength.

8. The apparatus of claim 6, wherein the first wavelength is about 650 nm and wherein the second wavelength is about 780 nm.

9. The apparatus of claim in 1 further comprising a third laser, wherein the first laser, the second laser and the third laser are configured to concurrently write to a first layer, a second layer and a third layer, respectively.

10. The apparatus of claim 9, wherein the third laser is configured to emit light having a wavelength of about 405 nm.

11. The apparatus of claim 1, wherein the first laser is configured to write a label marking and the second laser is configured to write the data marking.

12. The apparatus of claim 1, wherein the first laser and the second laser are each configured to write label markings.

13. A disc comprising:
a first layer of material configured to be written upon by a first laser;
a second layer of material configured to be written upon by a second laser, wherein the first layer is spaced from the second layer by a working distance difference between the first laser and the second laser.

14. The disc of claim 13, wherein the first layer is configured to absorb a first wavelength of light in response to being irradiated by the first laser and wherein the second layer is configured to absorb a second wavelength of light in response to being irradiated by the second laser.

15. The disc of claim 13, wherein the first layer is spaced from the second layer by a working distance difference of between about 195 μm and about 450 μm.

16. The disc of claim 13 further comprising a third layer of material, wherein the first layer, the second layer and the third layer are configured to absorb distinct wavelengths of light so as to provide cyan, magenta and yellow light upon being irradiated.

17. A method comprising:
writing a label upon a first layer and a second layer of an optical storage disc concurrently with a first laser and a second laser, respectively.

18. The method of claim 17, wherein writing includes writing label markings on at least one of the first layer and the second layer.

19. The method of claim 17 wherein writing upon the first layer comprises writing a first color label marking on the first layer and wherein writing on the second layer comprises writing a second color label marking on the second layer.

20. The method of claim 19, wherein the first color label marking is cyan, wherein the second color label marking is magenta and wherein the method further comprises writing a third yellow color label marking on a third layer.
